(19) United States
(12) Patent Application Publication
(10) Pub. No.: US 2025/0004682 A1
(43) Pub. Date: Jan. 2, 2025

(54) RECORDING SYSTEM, DATA GENERATING METHOD, AND MEDIUM

(71) Applicant: BROTHER KOGYO KABUSHIKI KAISHA, Nagoya (JP)

(72) Inventors: Masashi OHHASHI, Kasugai (JP); Satoru ARAKANE, Nagoya (JP); Koichi TSUGIMURA, Nagoya (JP); Naoyuki NAKAMURA, Nagoya (JP); Haruka AZECHI, Nagoya (JP); Yasuhiro NAKANO, Nagoya (JP)

(73) Assignee: BROTHER KOGYO KABUSHIKI KAISHA, Nagoya (JP)

(21) Appl. No.: 18/737,142

(22) Filed: Jun. 7, 2024

(30) Foreign Application Priority Data
Jun. 28, 2023 (JP) 2023-106381

(51) Int. Cl. G06F 3/12; G06K 15/00

(52) U.S. Cl. CPC G06F 3/1252; G06F 3/1208; G06F 3/1253; G06K 15/403

(57) ABSTRACT

There is provided a recording system including: a memory configured to store recording instructions, and medium size information. Each of the recording instructions includes image data, and image size information. The controller is configured to execute a data generating process of generating recording data, and is configured to generate, as the recording data, combined recording data in which images of first and second recording instructions are combined, the first recording instruction instructing recording of an image for one page or odd number pages. The combined recording data is configured to cause a recorder to record, on one recording medium, a first image of a final page among the image for the one page or the odd number pages of the first recording instruction, and a second image of an initial page among an image for one page or a plurality of pages specified by the second recording instruction.

### REFERENCE TO RELATED APPLICATIONS

This application claims priority from Japanese Patent Application No. 2023-106381 filed on Jun. 28, 2023. The entire content of the priority application is incorporated herein by reference.

### BACKGROUND ART

There is a known printing apparatus configured to print images for two pages on one cut sheet (recording medium) and to cut the cut sheet to be divided into two cut sheets.

### SUMMARY

However, in a case where the images for two pages are printed on one cut sheet (recording medium), as described in Japanese Patent Application Laid-open No. 2022-54896, a margin area on which an image is not recorded might be large in a cut sheet on which an image of the final page is printed, depending on the number of the pages of a print job, etc.

An object of the present disclosure is to provide a recording system, a data generating method, and a medium each of which is capable of reducing a margin area of one recording medium in a case of recording images for even number pages on the one recording medium.

According to a first aspect of the present disclosure, there is provided a recording system including:
a memory configured to store a plurality of recording instructions, and medium size information specifying a size of a recording medium to be conveyed to a recorder; and
a controller, wherein:
each of the plurality of recording instructions includes image data, and image size information specifying a size of an image based on the image data;
the controller is configured to execute a data generating process of generating recording data for causing the recorder to record the image, based on the plurality of recording instructions and the medium size information;
the controller is configured to generate, in the data generating process and as the recording data, combined recording data in which an image of a first recording instruction of the plurality of recording instructions and an image of a second recording instruction of the plurality of recording instructions are combined, the first recording instruction instructing recording of an image for one page or odd number pages; and
the combined recording data is configured to cause the recorder to record, on one recording medium, a first image of a final page among the image for the one page or the odd number pages of the first recording instruction, and a second image of an initial page among an image for one page or a plurality of pages specified by the second recording instruction.

According to a second aspect of the present disclosure, there is provided a data generating method executed by a controller in a recording system, the recording system including:
a memory configured to store a plurality of recording instructions, and medium size information specifying a size of a recording medium to be conveyed to a recorder; and
the controller,
wherein each of the plurality of recording instructions includes image data, and image size information specifying a size of an image based on the image data,
the method including:
executing a data generating process of generating recording data for causing the recorder to record the image, based on the plurality of recording instructions and the medium size information; and
generating, in the data generating process and as the recording data, combined recording data in which an image of a first recording instruction of the plurality of recording instructions and an image of a second recording instruction of the plurality of recording instructions are combined, the first recording instruction instructing recording of an image for one page or odd number pages,
wherein the combined recording data is configured to cause the recorder to record, on one recording medium, a first image of a final page among the image for the one page or the odd number pages of the first recording instruction, and a second image of an initial page among an image for one page or a plurality of pages specified by the second recording instruction.

According to a third aspect of the present disclosure, there is provided a non-transitory and computer-readable medium storing a program executable by a controller of a recording system, the recording system including:
a memory configured to store a plurality of recording instructions, and medium size information specifying a size of a recording medium to be conveyed to a recorder; and
the controller,
wherein each of the plurality of recording instructions includes image data, and image size information specifying a size of an image based on the image data,
the program is configured to cause the controller to:
execute a data generating process of generating recording data for causing the recorder to record the image, based on the plurality of recording instructions and the medium size information; and
generate, in the data generating process and as the recording data, combined recording data in which an image of a first recording instruction of the plurality of recording instructions and an image of a second recording instruction of the plurality of recording instructions are combined, the first recording instruction instructing recording of an image for one page or odd number pages,
wherein the combined recording data is configured to cause the recorder to record, on one recording medium, a first image of a final page among the image for the one page or the odd number pages of the first recording instruction, and a second image of an initial page among an image for one page or a plurality of pages specified by the second recording instruction.

In a case where a first recording instruction instructs a recording of an image for one page or odd number pages and a recording process is executed based on recording data generated based on the first recording instruction, a large margin area is generated in a recording medium on which an image of a final page of the first recording instruction is recorded. In contrast, in the present disclosure, in the above-described case, a combined recording data is generated in which an image of the first recording instruction and an image of the second recording instruction are combined. In a case where the recording process is executed based on the combined recording data, an image of an initial page of the second recording instruction is recorded on a recording medium on which the image of the final page of the first recording instruction is recorded. With this, the margin area can be reduced.

### BRIEF DESCRIPTION OF DRAWINGS

FIG. 1 is a perspective view of a printer according to an embodiment of the present disclosure.

FIG. 2 is a vertical cross-sectional view depicting an internal configuration of the printer of FIG. 1.

FIG. 3 is a block diagram depicting an electric configuration of the printer of FIG. 1.

FIGS. 4A, 4B and 4C are each a schematic view depicting an example of a screen displayed on a displaying part of the printer of FIG. 1.

FIG. 5 is a schematic view depicting a situation in a case where a “print” button is pressed in FIG. 4A and images of two print jobs are individually recorded, respectively, on two paper sheets.

FIG. 6 is a schematic view depicting a situation in a case where the “print” button is pressed in FIG. 4B and the images of two print jobs are recorded on one paper sheet.

FIG. 7 is a schematic view depicting a situation in the case where the “print” button is pressed in FIG. 4C and the images of two print jobs are recorded on one paper sheet.

FIG. 8 is a flowchart indicating the content of control executed by a CPU of the printer of FIG. 1.

### DESCRIPTION

In the following description, the respective direction of a printer 1 according to an embodiment of the present disclosure which are the up-down direction, left-right direction and front-rear direction are defined, with a state that the printer 1 is installed usably as the reference.

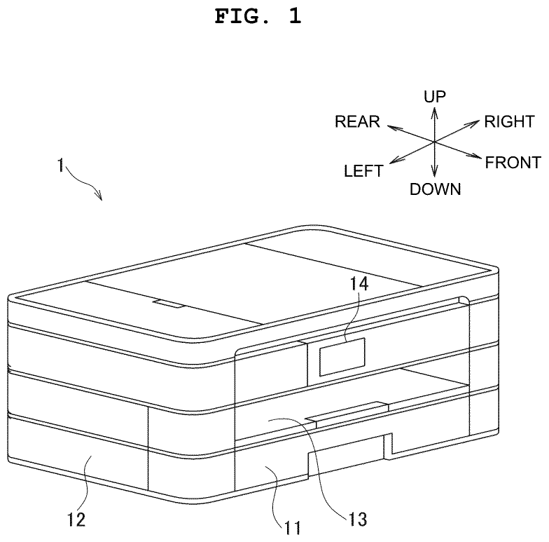

As depicted in FIG. 1, the printer 1 has a casing 12 having a substantially rectangular parallelepiped shape, a paper feed tray 11 disposed in a lower part of the casing 12, a paper discharge tray 13 disposed above the paper feed tray 11 in the casing 12, and a displaying part 14 disposed in the front surface of the casing 12. The feed tray 11 is detachably attached to the casing 12. The displaying part 14 is a display of the touch-panel system, and also functions as an input part.

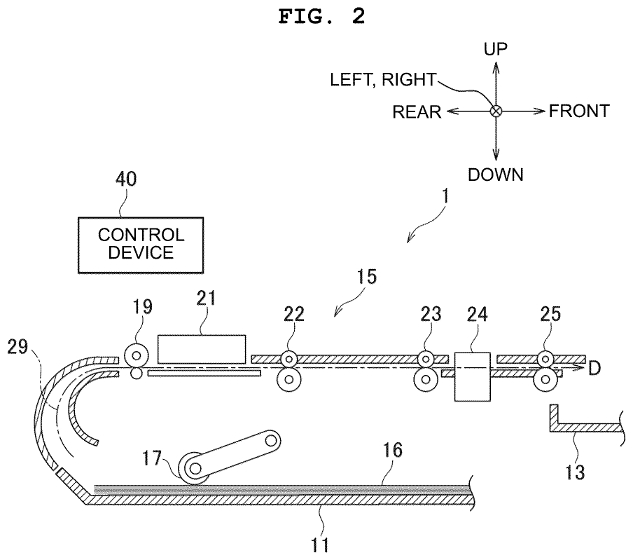

The printer 1 includes a conveying part 15, a recording part (recorder) 21, a cutting part 24, and a control device 40 (see FIG. 2) in the casing 12.

The paper feed tray 11 is capable of accommodating a plurality of paper sheets 16. The paper sheet 16 is an example of a “recording medium”.

The conveying part 15 conveys the paper sheet 16, which is accommodated in the paper feed tray 11, along a conveying route 29 passing below the recording part 21 and reaching the paper discharge tray 13. The conveying part 15 includes a paper feed roller 17, conveying roller pairs 19, 22, 23 and 25, and a conveying motor (not depicted in the drawings). The paper feed roller 17 and the conveying roller pairs 19, 22, 23 and 25 are driven to rotate by the conveying motor.

The paper feed roller 17 is disposed so as to make contact with a surface of an uppermost paper sheet 16 among the plurality of paper sheets 16 accommodated in the paper feed tray 11. In a case where the conveying motor is driven under the control of the control device 40, the paper feed roller 17 is rotated to thereby feed the uppermost paper sheet 16 to the conveying route 29. By the conveying roller pairs 19, 22, 23 and 25 rotating while pinching and holding the paper sheet 16, the paper sheet 16 is conveyed along the conveying route 29 in a conveying direction D (a direction along the conveying route 29).

The recording part 21 is of the ink-jet system, and includes an ink channel having a plurality of nozzles, and a driver IC. The plurality of nozzles is opened in the lower surface of the recording part 21. In a case where the driver IC is driven under the control of the control device 40, pressure is applied to the ink channel, thereby ejecting an ink from the plurality of nozzles. With this, dots of the ink (ink dots) are formed on the paper sheet 16 and an image is recorded on the paper sheet 16. The recording part 21 may be of either one of the line system and the serial system.

The cutting part 24 includes a cutting blade and a cutting motor. The cutting blade includes a fixed blade and a rotary blade. In a case where the cutting motor is driven under the control of the control device 40, the rotary blade moves in the left-right direction while rotating. With this, the paper sheet 16 which is conveyed by the conveyor 15 is cut so that the paper sheet 16 is divided into an upstream part and a downstream part of the conveying direction D.

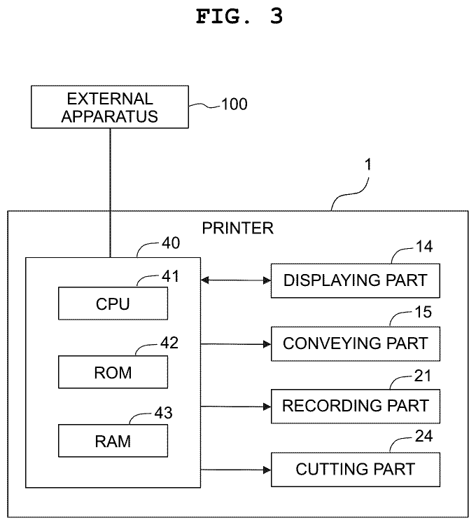

As depicted in FIG. 3, the control device 40 includes a CPU 41, a ROM 42, and a RAM 43. The CPU 41 is an example of a “controller”, and the RAM 43 is an example of a “memory”. A program, data, etc., with which the CPU 41 performs a variety of kinds of control are stored in the ROM 42. The RAM 43 temporarily stores data used by the CPU 41 in a case where the CPU 41 executes a program.

The control device 40 is electrically connected to the displaying part 14, the conveying part 15, the recording part 21, and the cutting part 24. Further, the control device 40 is electrically connected to an external apparatus 100 (such as a personal computer).

The RAM 43 stores a plurality of print jobs received from the external apparatus 100, and medium size information specifying the size of the paper sheet 16 in the paper feed tray 11 (namely, the paper sheet 16 to be conveyed to the recording part 21). The “print job” is an example of a “recording instruction”.

Each of the plurality of print jobs includes image data, image size information specifying the size of an image based on the image data, and orientation information specifying the orientation of the image based on the image data. The plurality of print jobs is classified user by user and is stored in the RAM 43.

The medium size information and the image size information are, for example, “A4”, “A5”, etc. The orientation information is “portrait” meaning that the long side of an image is along the conveying direction D, or a “landscape” meaning that the short side of the image is along the conveying direction D. A term “A4 portrait” means that the long side of an image of A4 size is along the conveying direction D. A term “A5 landscape” means that the short side of an image of A5 size is along the conveying direction D.

The medium size information is, for example, stored in the RAM 43 based on information inputted by a user via the displaying part 14 when the paper feed tray 11 is detached and attached. In the present embodiment, the medium size information is “A4”. Note that since the paper sheet 16 in the paper feed tray 11 is premised that the long side of the paper sheet 16 is along the conveying direction D (“portrait”), the paper sheet 16 in the paper feed tray 11 is “A4 portrait”.

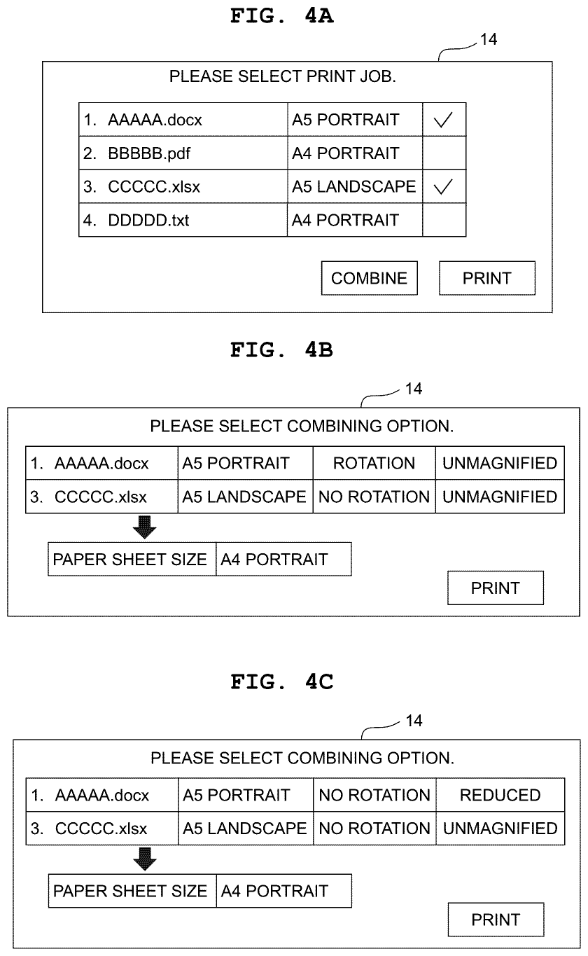

In a case where the CPU 41 determines that an instruction of a selective recording is received, the CPU 41 causes the displaying part 14 to display information of a plurality of print jobs transmitted by the user to the printer 1, and to display a message urging the user to select any one of the plurality of print jobs (see FIG. 4A). The term “selective recording” means that the recording is to be performed for an image of one print job or images of print jobs selected from the plurality of print jobs. For example, in a case where the authentication of the user by a password, etc., is completed, the CPU 41 determines that an instruction of the selective recording is received.

In FIG. 4A, a file name of image data (“AAAAA.docx”, etc.), image size information (such as “A5”, “A4”, etc.), and orientation information (“portrait” or “landscape”) are displayed on the displaying part 14, as the information of each of four print jobs “1” to “4”. Further, buttons of “combine” and “print” are displayed on the displaying part 14.

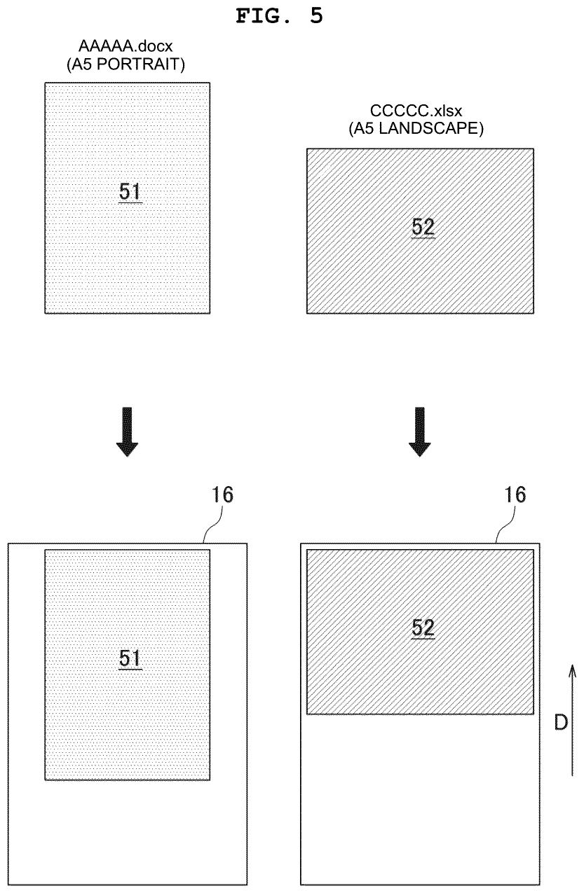

In a case where the user selects the print jobs “1” and “3” and presses the “print” button, the CPU 41 controls the conveying part 15 and the recording part 21 and executes a recording process so that an image 51 and an image 52 of, respectively, the two print jobs “1” and “3” are individually recorded on two paper sheets 16, as depicted in FIG. 5. After the image 51 of the print job “1” is recorded on one paper sheet 16, the image 52 of the print job “3” is recorded on another paper sheet 16. The another paper sheet 16 may be cut so that the another paper sheet 16 is divided into an upstream part in the conveying direction D (a part on which the image 52 is recorded) and a downstream part in the conveying direction D (a margin part).

In a case where the user selects the print job “1” and the print job “3” and presses the “combine” button, the CPU 41 causes the displaying part 14 to display options regarding the change of the orientation (“rotation” and “no rotation”) and options regarding the magnification (“unmagnified”, “magnified” and “reduced”) regarding each of the image 51 of the print job “1” and the image 52 of the print job “3” (see FIGS. 4B and 4C).

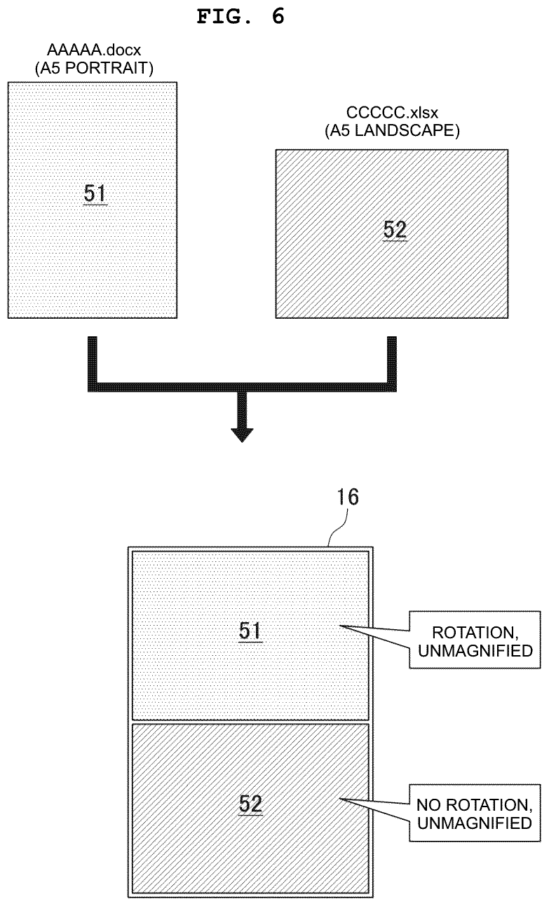

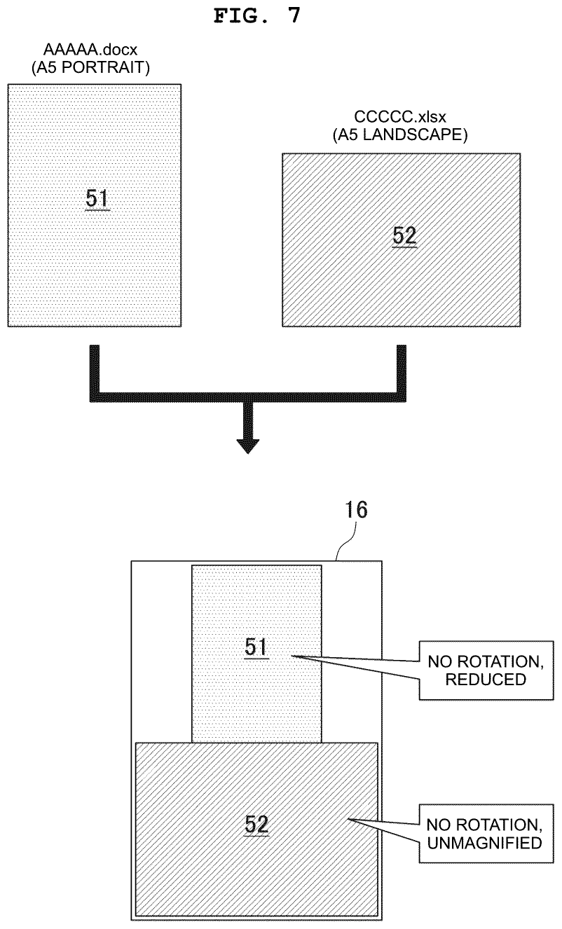

In FIGS. 4B and 4C, the option “rotation” means that the orientation of the image is to be rotated by 90 degrees (see the image 51 of FIG. 6). The option “no rotation” means that the orientation of the image is not to be changed (see the image 52 of FIG. 6, and the images 51 and 52 of FIG. 7). The option “unmagnified” means that the size of the image is not to be changed (see the images 51 and 52 of FIG. 6 and the image 52 of FIG. 7). The option “reduced” means that the size of the image is to be reduced (see the image 51 of FIG. 7). The option “magnified” means that the size of the image is to be magnified (not depicted in the drawings).

The CPU 41 displays the options by which the image 51 of the print job “1” and the image 52 of the print job “3” can be combined and recorded on one paper sheet 16 and by which any large margin area is not generated in the paper sheet 16, in displaying of the options regarding the change of orientation (“rotation” and “no rotation”) and the options regarding the magnification (“unmagnified”, “magnified” and “reduced”). For example, as depicted in FIG. 4B, in a case where the option “rotation” is selected as the option regarding the change of orientation with respect to the image of the print job “1”, only the option “unmagnified” is displayed as the option regarding the magnification. Further, in a case where the option “no rotation” is selected as the option regarding the change of orientation with respect to the image of the print job “3”, only the option “unmagnified” is displayed as the option regarding the magnification. As depicted in FIG. 4C, in a case where the option “no rotation” is selected as the option regarding the change of orientation with respect to the image of the print job “1”, only the option “reduced” is displayed as the option regarding the magnification.

As depicted in FIG. 4B, in a case where the user selects the options “rotation” and “unmagnified” regarding the image of the print job “1” and selects the options “no rotation” and “unmagnified” regarding the image of the print job “3”, and where the user presses the “print” button, the CPU 41 controls the conveying part 15 and the recording part 21 so as to execute the recording process so that the images 51 and 52 of the two print jobs “1” and “3”, respectively, are recorded on one paper sheet 16, as depicted in FIG. 6. FIG. 6 depicts a state that the orientation of the image 51 of the print job “1” is rotated by 90 degrees.

As depicted in FIG. 4C, in a case where the user selects the options “no rotation” and “reduced” regarding the image of the print job “1”, and selects the options “no rotation” and “unmagnified” regarding the image of the print job “3”, and where the user presses the “print” button, the CPU 41 controls the conveying unit 15 and the recording part 21 so as to execute the recording process so that the images 51 and 52 of the two print jobs “1” and “3”, respectively, are recorded on one paper sheet 16, as depicted in FIG. 7. FIG. 7 depicts a state that the image 51 of the print job “1” is reduced.

The CPU 41 executes a data generating process before executing the recording process.

In the data generating process, the CPU 41 generates recording data, which is data for causing the recording part 21 to record an image, based on the plurality of print jobs and the medium size information. In the present embodiment, the recording part 21 is of the ink-jet system, and the recording data is data specifying an amount of the ink ejected from each of the plurality of nozzles of the recording part 21 (any one of 0 (zero), small, medium and large).

In the data generating process before executing the recording process as depicted in FIGS. 6 and 7, the CPU 41 generates combined recording data as recording data in which the image 51 of the print job “1” (first recording instruction) satisfying a first condition among the four print jobs “1” to “4”, and the image 52 of the print job “3” (second recording instruction) satisfying a second condition among the four print jobs “1” to “4” are combined.

The first condition and the second condition may be mutually same or mutually different. The first condition may be, for example, a condition that the print job is selected by the user, a condition that a size specified by the image size information is smaller than a size specified by the medium size information, etc. The second condition may be, for example, the condition that the print job is selected by the user, the condition that the size specified by the image size information is smaller than the size specified by the medium size information, and a condition that a combination of the A4 and the A5 is allowed.

The print job “1” is a print job instructing a recording of an image for one page or odd number pages (that is, image(s) for n+1 pages, provided that “n” is zero or a natural number). In this case, the combined recording data is recording data for causing the recording part 21 to record, on one paper sheet 16, the image 51 (first image) of the final page of the image for the one page or the odd number pages of the print job “1” and the image 52 (second image) of a first page (that is, an initial page) of an image for one page or a plurality of pages specified by the print job “3”.

In the present embodiment, each of the print job “1” and the print job “3” (the first recording instruction and the second recording instruction) instructs the recording of the image for one page. In this case, the CPU 41 generates, in the data generating process, the combined recording data which is the recording data for causing the recording unit 21 to record the image 51 of the print job “1” and the image 52 of the print job “3” on one paper sheet 16.

In a case where the first recording instruction is configured to instruct a recording of images for the odd number pages being a plurality of pages, the CPU 41 generates, in the data generating process, recording data for causing the recording unit 21 to record an image of the first page up to an image of a penultimate page which is one page before the final page of the first recording instruction so that images for two pages are included in one paper sheet 16 or in each of a plurality of paper sheets 16. Further, the CPU 41 generates the combined recording data by which the image (first image) of the final page of the first recording instruction and the image (second image) of the first page of the second recording instruction are combined and recorded on one paper sheet 16.

In a case where the first recording instruction is configured to instruct the recording of the image for the one page or the odd number pages, a large margin area is generated in one paper sheet 16 if the image of the final page of the first recording instruction and the image of the first page of the second recording instruction are not combined and only one image of the final page of the first recording instruction is recorded on the one paper sheet 16. For example, a downstream part in the conveying direction D of the paper sheet 16 becomes a margin. In view of this, the present embodiment generates, in the above-described case, the combined recording data is generated in which the image of the final page of the first recording instruction and the image of the first page of the second recording instruction are combined. In a case where the recording process is executed based on the combined recording data, on the paper sheet 16 on which the image 51 (the first image) of the final page of the first recording instruction (print job “1”) is to be recorded, not only the image 51 but also the image 52 (the second image) of the first page of the second recording instruction (print job “3”) are recorded, as depicted in FIGS. 6 and 7. With this, the margin area can be reduced.

The “A5” specified by the image size information of the image 51 (first image) of the first recording instruction (print job “1”) and the “A5” specified by the image size information of the image 52 (second image) of the second recording instruction (print job “3”) are each half the size of the “A4” specified by the medium size information. In this case, the margin area can be reliably reduced by recording a combination of the images 51 and 52 of which sizes are mutually same (A5) on one paper sheet 16 of which size (A4) is twice the size (A5) of each of the images 51 and 52.

As depicted in FIG. 4B and FIG. 6, in the data generating process, the CPU 41 changes the orientation of at least one of the image 51 (first image) and the image 52 (second image) so as to generate the combined recording data. In this case, the margin area can be reduced efficiently.

As depicted in FIG. 4C and FIG. 7, in the data generating process, the CPU 41 magnifies or reduces (that is, performs scaling) at least one of the image 51 (first image) and the image 52 (second image) (that is, the image 51 and/or the image 52) so as to generate the combined recording data. In this case, the margin area can be reduced efficiently.

As depicted in FIG. 4C and FIG. 7, in the data generating process, the CPU 41 performs at least one of the change of orientation and the magnification or reduction (that is, the change of orientation and/or the magnification or reduction (the scaling)), with respect to at least one of the image 51 (first image) and the image 52 (second image) to thereby make the size of the image 51 (first image) and the size of the image 52 (second image) mutually same in the conveying direction D and/or the left-right direction so as to generate the combined recording data. In this case, by adjusting the image 51 and the image 52 to have the mutually same sizes in the conveying direction D and/or the left-right direction and then combining the image 51 and the image 52, the margin area can be reduced further efficiently.

In the data generating process, the CPU 41 receives selecting data which is based on an instruction of the user via the screen depicted in FIG. 4A and which specifies the print job “1” (the first recording instruction) and the print job “3” (the second recording instruction), and combines the image 51 (first image) of the print job “1” and the image 52 (second image) of the print job “3” each of which is included in the print jobs “1” to “4” and which are specified by the selecting data. In this case, the images desired by the user can be obtained.

After the CPU 41 has received the selecting data specifying the print job “1” (the first recording instruction) and the print job “3” (the second recording instruction), the CPU 41 performs notification of at least any one of the change of orientation and the magnification or reduction, regarding at least one of the image 51 (the first image) of the print job “1” and the image 52 (the second image) of the print job “3” which are included in the four print jobs “1” to “4” and which are specified by the selecting data (see FIGS. 4B and 4C). Then, the CPU 41 performs at least one of the change of orientation and the magnification or reduction regarding at least one of the images 51 and 52, based on the instruction of the user in accordance with this notification, thereby generating the combined recording data. In this case, the margin area can be reduced in the images desired by the user.

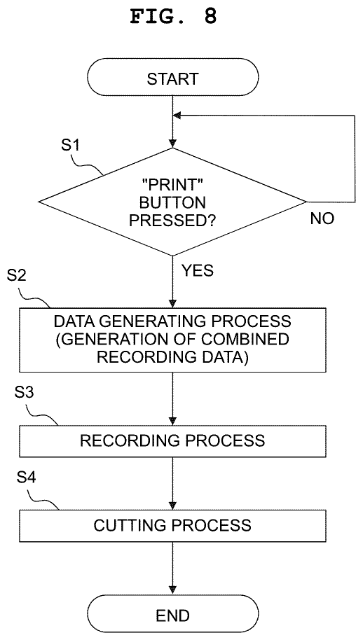

After the data generating process, the CPU 41 executes a recording process of causing the recording part 21 to record the images on the paper sheet 16 based on the recording data generated in the data generating process and a cutting process of causing the cutting part 24 to cut the paper sheet 16 so that the image 51 (the first image) and the image 52 (the second image) are divided from each other. Specifically, as depicted in FIG. 8, in a case where the CPU 41 determines that the user has pressed the “print” button (step S1: YES), the CPU 41 executes the data generating process (step S2) as described above, then executes the recording process (step S3), further executes the cutting process (step S4), and then ends this routine. In this case, since the paper sheet 16 is cut in the printer 1, the user is not required to cut the paper sheet 16, thereby saving the time and effort for the cutting. Note that the cutting process may be executed either before or after the recording process.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, although the cutting part 24 in the above-described embodiment is disposed downstream of the recording part 21 in the conveying direction D, the cutting part 24 may be disposed upstream of the recording part 21 in the conveying direction D.

Although the images for 2 (two) pages are recorded on one recording medium, in the above-described embodiment, images for 4 (four) pages, 6 (six) pages, etc., may be recorded on one recording medium.

The first recording instruction and the second recording instruction are not limited to being based on the instruction of the user. Each of the first and second recording instructions may be selected by the controller among a plurality of recording instructions, based on a predetermined condition.

The recording medium is not limited to the paper sheet, and may be cloth, a resin member, etc.

The recording part is not limited to being of the ink-jet system, and may be of the laser system, the thermal transfer system, etc.

The present disclosure is not limited to being applicable to the printer, and may be applicable also to facsimiles, copy machines, multifunction peripherals, etc.

The present disclosure is not limited to being applicable to the recording apparatus such as the printer, and may be applicable also to an external apparatus (such as a personal computer) to be connected to a recording apparatus, or to a combination of a recording apparatus and an external apparatus. The recording system according to the present disclosure may not be required to include the recording part and the cutting part.

What is claimed is:

1. A recording system comprising:
a memory configured to store a plurality of recording instructions, and medium size information specifying a size of a recording medium to be conveyed to a recorder; and
a controller, wherein:
each of the plurality of recording instructions includes image data, and image size information specifying a size of an image based on the image data;
the controller is configured to execute a data generating process of generating recording data for causing the recorder to record the image, based on the plurality of recording instructions and the medium size information;
the controller is configured to generate, in the data generating process and as the recording data, combined recording data in which an image of a first recording instruction of the plurality of recording instructions and an image of a second recording instruction of the plurality of recording instructions are combined, the first recording instruction instructing recording of an image for one page or odd number pages; and
the combined recording data is configured to cause the recorder to record, on one recording medium, a first image of a final page among the image for the one page or the odd number pages of the first recording instruction, and a second image of an initial page among an image for one page or a plurality of pages specified by the second recording instruction.

2. The recording system according to claim 1, wherein:
the first recording instruction satisfies a first condition, and/or the second recording instruction satisfies a second condition;
the first condition is a condition that the first recording instruction is a recording instruction, of the plurality of recording instructions, selected by a user and/or a condition that a size specified by the image size information of the first recording instruction is smaller than the size specified by the medium size information; and
the second condition is a condition that the second recording instruction is a recording instruction, of the plurality of recording instructions, selected by a user and/or a condition that a size specified by the image size information of the second recording instruction is smaller than the size specified by the medium size information and/or a condition that the size specified by the image size information of the second recording instruction is A5 in a case where the size specified by the image size information of the first recording instruction is A4 and that the size specified by the image size information of the second recording instruction is A4 in a case where the size specified by the image size information of the first recording instruction is A5.

3. The recording system according to claim 1, wherein each of the image size information of the first image and the image size information of the second image specifies a size which is half the size specified by the medium size information.

4. The recording system according to claim 1, wherein in the data generating process, the controller is configured to change orientation of the first image and/or the second image so as to generate the combined recording data.

5. The recording system according to claim 1, wherein in the data generating process, the controller is configured to perform scaling of the first image and/or the second image so as to generate the combined recording data.

6. The recording system according to claim 1, wherein in the data generating process, the controller is configured to perform scaling and/or change of orientation with respect to the first image and/or the second image to thereby make a size of the first image and a size of the second image mutually same, in a conveying direction of the recording medium and/or in a width direction orthogonal to the conveying direction and orthogonal to a facing direction in which the recorder and the recording medium face to each other, so as to generate the combined recording data.

7. The recording system according to claim 1, wherein in the data generating process, the controller is configured to:
receive selecting data which is based on an instruction of a user and which specifies the first recording instruction and the second recording instruction; and
combine the first image of the first recording instruction, of the plurality of recording instructions, specified by the selecting data, and the second image of the second recording instruction, of the plurality of recording instructions, specified by the selecting data.

8. The recording system according to claim 7, wherein in the data generating process, the controller is configured to:
perform a notification of scaling and/or change of orientation with respect to the first image of the first recording instruction, of the plurality of recording instructions, specified by the selecting data, and/or the second image of the second recording instruction, of the plurality of recording instructions, specified by the selecting data, after receiving of the selecting data; and
generate the combined recording data by performing the scaling and/or the change of the orientation with respect to the first image and/or the second image based on the instruction of the user in accordance with the notification.

9. The recording system according to claim 1, further comprising:
the recorder; and
a cutter configured to cut the recording medium,
wherein the controller is configured to further execute, after the data generating process:
a recording process of causing the recorder to record an image on the recording medium, based on the recording data; and
a cutting process of causing the cutter to cut the recording medium so as to divide the first image and the second image from each other.

10. A data generating method executed by a controller in a recording system, the recording system including:
a memory configured to store a plurality of recording instructions, and medium size information specifying a size of a recording medium to be conveyed to a recorder; and
the controller,
wherein each of the plurality of recording instructions includes image data, and image size information specifying a size of an image based on the image data,
the method comprising:
executing a data generating process of generating recording data for causing the recorder to record the image, based on the plurality of recording instructions and the medium size information; and
generating, in the data generating process and as the recording data, combined recording data in which an image of a first recording instruction of the plurality of recording instructions and an image of a second recording instruction of the plurality of recording instructions are combined, the first recording instruction instructing recording of an image for one page or odd number pages,
wherein the combined recording data is configured to cause the recorder to record, on one recording medium, a first image of a final page among the image for the one page or the odd number pages of the first recording instruction, and a second image of an initial page among an image for one page or a plurality of pages specified by the second recording instruction.

11. A non-transitory and computer-readable medium storing a program executable by a controller of a recording system, the recording system including:
a memory configured to store a plurality of recording instructions, and medium size information specifying a size of a recording medium to be conveyed to a recorder; and
the controller,
wherein each of the plurality of recording instructions includes image data, and image size information specifying a size of an image based on the image data,
the program is configured to cause the controller to:
execute a data generating process of generating recording data for causing the recorder to record the image, based on the plurality of recording instructions and the medium size information; and
generate, in the data generating process and as the recording data, combined recording data in which an image of a first recording instruction of the plurality of recording instructions and an image of a second recording instruction of the plurality of recording instructions are combined, the first recording instruction instructing recording of an image for one page or odd number pages,
wherein the combined recording data is configured to cause the recorder to record, on one recording medium, a first image of a final page among the image for the one page or the odd number pages of the first recording instruction, and a second image of an initial page among an image for one page or a plurality of pages specified by the second recording instruction.
